(19) United States
(12) Patent Application Publication
(10) Pub. No.: US 2018/0352843 A1
(43) Pub. Date: Dec. 13, 2018

(54) Methods and compositions to slow down aging in cells and organisms

(71) Applicant: Kris VERBURGH, Puurs (BE)

(72) Inventor: Kris VERBURGH, Puurs (BE)

(21) Appl. No.: 15/779,228

(22) PCT Filed: Dec. 13, 2016
(86) PCT No.: PCT/EP2016/080815

§ 371 Date: May 25, 2018

Related U.S. Application Data
(60) Provisional application No. 62/266,632, filed on Dec. 13, 2015.

(51) Int. Cl. A23L 33/105; A23L 33/125; A23L 33/17; A23L 33/135

(52) U.S. Cl. CPC A23L 33/105; A23L 33/125; A61Q 19/08; A23L 33/135; A23L 33/17

(57) ABSTRACT

A method to slow down and mitigate aging and to maintain health by administering a composition comprising at least one protein-homeostasis-influencing saccharide-based substance, an anti-amyloidogenic substance, a Krebs cycle metabolite, glycine, gingko biloba, low dose lithium, a prebiotic, or combinations thereof, enabling a synergistic and enhancing effect on the aging process and well-being due to their interaction and synergetic influence on protein homeostasis and various other aging-related mechanisms.

### PROBLEM

Aging causes 100 000 deaths daily, out of approximately 150 000 people that die every day. Various methods to slow down the aging process have been proposed, like food supplements, beverages, foods and other products comprising substances purported to slow down aging. However, many methods claiming to retard aging do not slow down or mitigate the aging process. For example, various vitamins, minerals and antioxidants (like vitamin A, vitamin E, co-enzyme Q10, etc.) are being said to slow down aging but they don't retard the aging process, nor do they reduce mortality.(1-3) Some antioxidants can even increase mortality(1) or the risk of diseases like cancer(4) or can undo the beneficial effects or exercise.(5) We need better scientifically-based substances that can have a positive impact on healthy lifespan and the aging process.

One important reason why many substances that fail to retard or mitigate the aging process is that they are based on outdated explanations for the aging process, like the often quoted ‘free radical theory of aging’. This theory posits that aging is caused by free radicals which are mainly generated by our metabolism. These free radicals damage the cells, which leads to aging. Antioxidants can neutralize free radicals and therefore allegedly can slow down aging. However, studies show that antioxidants do not retard aging.(1) Antioxidants can even increase mortality(1) and the risk of cancer(4), and undo the beneficial effects of exercise.(5) Additionally, free radicals (which are neutralized by antioxidants) can be beneficial and increase lifespan.(6)

### Solution

One of the main reasons why so many methods and compositions fail to slow down aging is a wrong focus on the real causes of aging. It is often believed that aging is caused by free radical damage (of the DNA for example), which causes cellular deterioration resulting in aging. However, as stated before, reducing free radical damage does not increase life span according to many scientific studies.

One embodiment of this invention wants to provide a solution to this problem, by targeting processes that really cause or play an important role in aging by using substances that impact these processes. Examples of such processes that are involved in aging and can lead to aging are:

A. Deterioration of Protein Homeostasis (Proteostasis).

Protein homeostasis is the maintenance of the proteins inside and around the cells. Protein homeostasis controls the production, folding and degradation of proteins. Adequate protein homeostasis implies a ‘healthy protein environment’. One of the reasons we age is because proteins accumulate inside and around the cells, indicating reduced or impaired protein homeostasis. More specifically, accumulating proteins can form protein ‘clumps’ (sometimes called ‘amyloid’), which hampers the functioning of the cell, causing the cell to work less well and to age. Protein clumps or aggregates damage and can even ‘suffocate’ the cells, causing them to deteriorate and die. This protein accumulation and deterioration of protein homeostasis is one of the reasons why we age. Accumulation of proteins inside and around brain cells plays a role in brain aging. Accumulation of proteins in the blood vessel walls contributes to hardened and aged blood vessels which are prone to breaking or clogging. Accumulation of proteins in the heart muscle cells contributes to reduced pumping function of the heart and thus to an ‘old heart’.

This buildup of proteins is sometimes referred to as proteinopathy (‘disease of proteins’) or proteotoxicity (‘toxicity by proteins’), or more generally described as reduced protein homeostasis, in which ‘protein homeostasis’ refers to the normally stable and relatively constant conditions regarding the amount of proteins inside and outside cells.

Proteinopathy and more specifically the accumulation and aggregation of proteins is accelerated when proteins are:
Damaged. Damaged proteins tend to accumulate more easily, leading to proteinopathy.
Misfolded. Misfolded proteins are proteins that are not properly folded. This makes that the proteins have a slightly different shape, making them more prone to accumulation and aggregation.
Accumulating due to reduced autophagy (‘digestion of proteins’). Proteins accumulate more in and around the cells when they are not sufficiently broken down by autophagy.

Specific molecules called ‘chaperones’ can prevent or inhibit the formation of damaged or misfolded proteins, for example by making direct contact with proteins and so helping them to fold properly or stabilizing them. Anti-amyloidogenic substances reduce the formation of protein aggregates or clumps (often called ‘amyloid’), by for example occupying or making contact with specific protein areas where proteins come in contact with each other normally enabling them to clump together. By interfering with these amyloidogenic regions these substances hamper aggregation of proteins and reduce amyloid formation (protein aggregates). Reducing protein damage and protein misfolding and increasing the concentration of chaperone-molecules and anti-amyloidogenic substances in the cell can mitigate and slow down the aging process and extend healthy lifespan.

Autophagy is the clearance of cellular waste like proteins or protein aggregates that tend to accumulate during aging. Reduced autophagy leads to more accumulation of proteins, protein aggregates and other cellular waste and cell organelles (like damaged mitochondria) and accelerates or exacerbates the aging process. Improving autophagy can mitigate and slow down the aging process.

Processes like increased autophagy, increased chaperone activity or increased anti-amyloidogenic activity can slow down protein aggregation, proteotoxicity and proteopathy and improve and maintain protein homeostasis (a healthy protein environment), which can mitigate or slow down aging. Specific methods, compositions, foods, beverages and other substances and products need to be developed that that influence or improve protein homeostasis and mitigate and slow down the aging process during lifespan, by for example increasing autophagy, stabilizing and protecting proteins or slowing down the accumulation of proteins and other cellular (waste) products.

B. Epigenetic Changes.

Another reason why we age is because of epigenetic changes. Epigenetic changes cause specific DNA regions to be more or less active than they should, which impedes cellular function. More specifically, epigenetic changes result in specific DNA regions that are more or less expressed so that these regions are more or less transcribed (‘read’) and ‘translated’ to produce specific proteins. When we get older, epigenetic changes occur so that cellular function deteriorates and the cell ages.

C. Mitochondrial Dysfunction.

Mitochondria are the power plants of cells. Mitochondria provide the energy in the form of ATP that drives almost all cellular processes. As time passes, the mitochondria deteriorate, which plays a role in the aging process.

Too much focus on outdated aging mechanisms, like the free radical theory of aging and antioxidants, among other things, makes that there currently is a scarcity of methods and compositions available that for example have been shown to:
extend lifespan in lab animals and/or humans;
directly interfere with aging mechanisms, like reduced protein homeostasis, epigenetic changes or mitochondrial dysfunction;
have a synergistic effect, because they comprise substances that influence similar and/or different aging mechanisms, like reduced protein homeostasis, epigenetic changes or mitochondrial dysfunction.

Another problem is that despite the fact that some other inventions include certain substances that are mentioned in this patent application, they only focus on a specific disease (or a specific group of diseases) but not on the aging process itself.

For example, patent application CA2722314 describes in claim 7 trehalose as an autophagy inducer that can help treating Alzheimer's disease. However, this invention only addresses a disease (Alzheimer's disease, or eventually other closely-related neurodegenerative diseases). It does not use trehalose to slow down aging, nor does it describes the effect of trehalose on the whole body (instead it focuses only on the brain), nor does it describes the potential synergistic effects on aging of other substances mentioned in this document.

US Patent Application US20040038929A1 describes a composition containing trehalose and an amino sugar like N-acetyl-glucosamine to treat articular disorders. This invention doesn't address aging, it only addresses articular disorders. It also uses amino-sugars based on the rationale that they are beneficial for the cartilage because they are the building blocks of the cartilage (N-acetyl-glucosamine is an important component of cartilage). Yet, the recognition hasn't been made that N-acetyl-glucosamine can have much further wide-ranging effects on the whole body than only its effect on cartilage, nor that it can slow down aging because of its interference with protein homeostasis, an important aging mechanism.

Patent Application CA2737797A1 describes a composition comprising trehalose and curcuma to improve brain health and neurodegenerative diseases. This invention focuses only on the nervous system, does not address aging, nor does it describes or recognizes the synergistic effect of trehalose with curcuma on protein homeostasis and aging, nor does it mention other synergistic substances, like glucosamine, acetyl-glucosamine, mannitol, malate, fumarate, and others, which are however described in this patent application.

Patent Application US20090162487 describes compositions comprising trehalose, glycine and malate in a beverage. However, the main goal of this proposed composition is to create beverages with a good (sweet) taste and desirable mouthfeel (creating ‘sweet taste improving compositions’). As with many other ‘sweet taste improving compositions’, no realization is made or emphasis is placed on how these ingredients can mitigate the aging process, nor their synergistic effects on the aging process are recognized.

Patent Application WO2001039615A1 describes a drink containing trehalose and caffeine to maintain blood glucose level during and after exercise. It doesn't use this composition to mitigate aging, nor does it recognize the synergistic effect of trehalose and caffeine in relation to aging and health. Caffeine is added to a lot of health or sport drinks with the main goal of increasing stamina and alertness, not to retard or mitigate the aging process, or trehalose is added to provide energy or to counteract dehydration during exercise.

One embodiment to slow down and mitigate aging and improve health can comprise, but is not limited to, at least one of the following substances or a combination thereof, in which their synergistic effects on the aging process and health are recognized and disclosed:

A) A protein-homeostasis-influencing saccharide-based substance that slows down or mitigates aging mechanisms like proteinopathy, by for example inducing autophagy, reducing protein misfolding, reducing protein damage or protein aggregation, e.g. (but not limited to) trehalose, mannitol, glucosamine, acetyl-glucosamine or a combination thereof. We recognize the synergistic effect between these substances in relation to aging, longevity, health, metabolism and more specifically protein homeostasis. For example, trehalose and mannitol improve protein homeostasis by acting as a chaperone for proteins and by inducing autophagy (clearance of protein aggregates), while acetyl-glucosamine improves protein homeostasis by influencing the endoplasmatic reticulum-related unfolded protein response, while glucosamine improves protein homeostasis by increasing autophagy or by increasing amino acid turnover (amino acids are the building blocks of proteins) and by inhibiting glycolysis (the burning of sugar molecules as a fuel) which leads to less break-down of sugar-like molecules like trehalose, which further potentiates the effect of trehalose.

Exploiting these synergistic effects by combining trehalose, mannitol, glucosamine and/or acetyl-glucosamine can improve their effectiveness.

B) A substance or composition that has a senescence-retarding effect by virtue of its anti-amyloidogenic effect, e.g. (but not limited to) caffeine, curcuminoids, turmeric, turmeric extracts, polyphenols, or a combination thereof. Recognized is the synergistic effect of anti-amyloidogenic substances with protein-homeostasis-influencing saccharide-based substances (e.g. trehalose, acetyl-glucosamine, etc) on protein homeostasis since an anti-amyloidogenic substance slows down protein aggregation (protein aggregates are often called ‘amyloid’), while a protein-homeostasis-influencing saccharide-based substance also slows down protein aggregation by for example its chaperone-activity or by inducing autophagy (clearance of proteins).

C) A substance that has an additional senescence-retarding effect by acting on protein homeostasis and/or other aging mechanisms, thus having a synergistic effect to slow down or mitigate aging together with protein-homeostasis-influencing saccharide-based substances, anti-amyloidogenic substances or a combination thereof. Examples of substances with an additional effect are:

1) lithium, which induces autophagy, enabling a synergistic effect with substances that improve protein homeostasis, like a protein-homeostasis-influencing saccharide-based substance (e.g. trehalose) which for example upregulates autophagy and protects proteins via its chaperone/stabilizing activity), and an anti-amyloidogenic substance (e.g. caffeine), which slows down protein aggregation. Lithium also causes epigenetic changes (another synergistic beneficial effect beyond improving protein homeostasis). In one embodiment, a very low dose lithium is preferred, because a standard dose (used by physicians) can have side-effects. Research shows that a very low dose lithium exhibits beneficial effects on the aging process and the body.

2) a Krebs cycle metabolite (e.g., but not limited to, malate, fumarate or pyruvate) that, among other things, affects mitochondria and slows down mitochondrial dysfunction (another beneficial synergistic effect than only improving protein homeostasis).

3) glycine: studies show that glycine improves mitochondrial function (for example via SHMT2 and CGAT proteins), so therefore it has a synergistic effect on the aging process with a Krebs cycle metabolite (e.g. malate) that also improves mitochondrial function. Additionally, glycine exerts epigenetic effects, so it has a synergistic effect with lithium that also has an epigenetic effect. Also, glycine has a beneficial effect on protein homeostasis, for example because it stabilizes proteins, has a chaperone-like activity and beneficially interferes with protein synthesis by manipulating the aging-accelerating methionine pathway. So glycine has a synergistic effect with a protein-homeostasis-influencing saccharide-based substance and an anti-amyloidogenic substance, which both also improve protein homeostasis.

4) a cognitive enhancer e.g. (but not limited to) ginkgo biloba: gingko biloba extends life span in lab animals, for example by improving mitochondrial function, making it synergistic with a Krebs cycle metabolite (e.g. malate) and glycine which also improve mitochondrial function. Additionally, ginkgo biloba also contains anti-amyloidogenic substances, which enable an synergistic effect with other anti-amyloidogenic compounds (e.g. caffeine) and protein-homeostasis-influencing saccharide-based substances (e.g. trehalose). Ginkgo biloba also has the potential to improve brain function (e.g. memory, cognition, attention, mood, increased brain blood flow, . . . ), as do caffeine, lithium and glycine, so a combination of these substances produce a synergistic effect on brain functioning.

5) a prebiotic substance that influences the microbiota composition in the gut, e.g., but not limited to, oligosaccharides (e.g. FOS, GOS, etc), polysaccharides (e.g. inuline). Improved gut function has a synergistic effect together with other substances that mitigate aging (like protein-homeostasis-influencing saccharide-based substances e.g. trehalose), anti-amyloidogenic substances, lithium, glycine, Krebs cycle metabolites, gingko biloba or a combination thereof) because improved gut function mitigates aging by, among other things, reducing whole-body inflammation, which generally increases during aging and contributes to the aging process (‘inflammaging’).

Additionally, the synergistic effect is recognized of an embodiment comprising a prebiotic substance with a substance that influences protein homeostasis, like a protein-homeostasis-influencing saccharide-based substance (e.g. trehalose), an anti-amyloidogenic compound (e.g. caffeine), lithium, glycine, gingko biloba, or combinations thereof, because prebiotics improve the microbiota composition of the gut which leads to improved protein homeostasis because:

healthy gut microorganisms produce substances that reduce protein aggregation and improve protein homeostasis.

studies show that protein-aggregation can start in the gut via protein aggregation in gut nerves that spreads to the brain and other organs, there causing symptoms, implicating a role of unhealthy gut bacteria in protein homeostasis.

Additionally, an extra benefit is recognized of an embodiment comprising a sweet-tasting protein-homeostasis-influencing saccharide-based compound (e.g. trehalose or mannitol), a sweet-tasting prebiotic (e.g. FOS, inuline, etc), a sweet-tasting amino-acid like glycine, or a combination thereof, whether or not together with a polyol (e.g. erythritol), to create a much healthier sweetener composition compared to other sweetener compositions, comprising polyols, high-potency sweeteners (e.g. stevia, sucralose, aspartame, acesulfame potassium, saccharine) or combinations thereof since such an embodiment not only produces a sweet taste, but also has a synergistic effect on improving protein homeostasis, aging, metabolism and health for the reasons mentioned earlier.

Another additional benefit of one embodiment is that it can synergistically improve brain function, because it can comprise substances like caffeine, glycine, ginkgo biloba, lithium or combinations thereof, each substance individually having the capacity to improve brain function, e.g. improved cognitive function, memory, increased wakefulness, mood, alertness, reduced fatigue, improved brain blood flow, improved brain insulin sensitivity, improved capacity to handle stress, . . . .

Here follows a more detailed description of the substances that one embodiment can comprise, but is not limited to, nor does one embodiment need to comprise all substances:

A) Trehalose is a disaccharide that is used in the food industry as a sweetener and as a food preservative. However, trehalose has much more interesting effects besides tasting sweet and being a preservative, like the effect of trehalose on protein homeostasis and its role in aging and health, because trehalose is an inducer of autophagy and can function as a chemical chaperone. As a chemical chaperone trehalose protects and stabilizes proteins from misfolding and damage. Trehalose can inhibit aggregation of proteins. Trehalose can extend lifespan in lab animals. Besides trehalose, mannitol is another example of a protein-homeostasis-influencing saccharide-based molecule with chaperone activity.

B) Acetyl-glucosamine (N-acetylglucosamine, N-acetyl-D-glucosamine, GlcNAc, NAG) is an amino-sugar that is sometimes used as a food supplement to treat articular problems or inflammatory bowel disease. The rationale for this approach is that acetyl-glucosamine (and other amino-sugars) are considered to be necessary components in the synthesis of cartilage (proteoglycans) or as components of the gut lining. However, acetyl-glucosamine also acts as an anti-aging and longevity agent in view of its role in protein homeostasis and in aging and health, because acetyl-glucosamine extends lifespan of lab animals and this for example by improving endoplasmatic reticulum (ER)-related protein homeostasis, involving among other things the endoplasmatic reticulum-mediated unfolded protein response (ER-UPR) and the upregulation of chaperone molecules, which improve protein homeostasis by for example reducing the risk of protein malformation, protein misfolding and protein aggregation.

Acetyl-glucosamine is often confused with glucosamine (see further below). However, both substances have different working mechanisms. For example, acetyl-glucosamine influences endoplasmatic reticulum-related protein homeostasis, while glucosamine inhibits glycolysis (the burning of sugars as fuel).

C) Glucosamine is an amino-sugar that is often used as a food supplement to treat articular problems or to improve cartilage function. The rationale behind this is that glucosamine (and other amino sugars) are considered as necessary components for the synthesis of cartilage (proteoglycans). However, one embodiment here relates to glucosamine as an anti-aging and longevity agent in view of the role of glucosamine in protein homeostasis and the involvement of protein homeostasis in aging and health, because glucosamine extends lifespan in lab animals and this by processes like for example activating autophagy and improving mitochondrial function by inhibition of glucose metabolism (glucosamine acts as an inhibitor of glycolysis, the burning of sugar molecules as a fuel). The inhibition of glycolysis leads to mitochondrial biogenesis (creation of more mitochondria, which produce energy for the cell) for example via AMPK activation or leads to a shift from glucose as a fuel to amino acids and other (mito)hormetic changes. These and other processes leads to increased life and health span, independently from the hexosamine pathway which involves molecules like acetyl-glucosamine.

D) Anti-amyloidogenic substances like for example caffeine, curcuminoids, extracts of Curcuma longa and polyphenols (e.g. flavonoids) can slow down protein aggregation. One possible mechanism via which these substances exert their anti-amyloidogenic properties is their ability to make contact with specific protein areas that are called ‘amyloidogenic regions’. These are the areas where proteins make contact with each other to stick or clump together. By occupying these regions, these anti-amyloidogenic substances hinder the clumping or aggregation of proteins (protein aggregates are often called ‘amyloid’). Substances like for example caffeine also have other anti-aging and health effects.

The additional synergistic effect is recognized by combining an anti-amyloidogenic substance with other substances that affect protein homeostasis, like a protein-homeostasis-influencing saccharide-based substance (e.g. trehalose, acetyl-glucosamine, glucosamine or combinations thereof), lithium or glycine (mentioned before). The anti-amyloidogenic substance retards protein aggregation, and so can a protein-homeostasis-influencing saccharide-based substance, lithium or glycine by their protein stabilizing chaperone-activity or by inducing autophagy, leading to less accumulation and more clearance of protein aggregates that are involved in the aging process.

Examples of anti-amyloidogenic compounds are, but are not limited to, caffeine, caffeic acid, curcuminoids, Curcuma longa-extracts, rosmarinic acid, resveratrol, myricetin, morin, quercetin, gossypetin, apomorphine, kaempferol, exifone, baicalein, apigenin, catechin, epicatechin, epicatechin-gallate, EGCG, NDGA, hypericin, fisetin, tannic acid, (pro)anthocyanidins, purpurogallin, olive oil, oleuropein, oleocanthal, or combinations thereof.

E) Krebs cycle metabolites like malate, fumarate or pyruvate improve mitochondrial function and health. We recognize the synergistic effect on the aging process and health by combining Krebs cycle metabolites with substances that also improve mitochondrial functioning, like glycine, gingko biloba and/or lithium, but also with other substances that affect the aging process, like anti-amyloidogenic substances (e.g. caffeine) and protein-homeostasis-influencing saccharide-based substances (e.g. like for example trehalose, acetylglucosamine and/or glucosamine), or combinations thereof. These latter two substances (anti-amyloidogenic substances and protein-homeostasis-influencing saccharide-based substances) also directly or indirectly improve mitochondrial function.

F) Glycine is an amino-acid. It increases life span in lab animals. One of the mechanisms by which it produces this effect is by improving mitochondrial function, inducting epigenetic changes (both in nuclear and mitochondrial DNA) and improving protein homeostasis by for example exhibiting a chaperone-like and protein stabilizing activity. We recognize the synergistic effect of glycine on the aging process and health with substances that also improve mitochondrial function (e.g. Krebs cycle metabolites (e.g. malate), ginkgo biloba, . . . ), substances that also have epigenetic effects (e.g. lithium) and substances that also improve protein homeostasis (e.g. anti-amyloidogenic substances (e.g. caffeine), protein-homeostasis-influencing saccharide-based substances (e.g. trehalose, acetylglucosamine and/or glucosamine)), or combinations thereof.

G) Lithium is a substance that induces autophagy, which leads to improved clearance of protein aggregates and reduced accumulation of protein and/or other waste products in and around cells. Lithium also has the additional effect of bringing about epigenetic changes that are beneficial to health and mitigate and slow down the aging process. Additionally, lithium has also many other beneficial synergistic effects regarding mitigating the aging process and improving health, like inhibiting glycogen synthase-kinase 3-alpha, glycogen synthase-kinase-3-beta and inositol monophosphatase (IMP). In pharmaceutical doses lithium can sometimes have serious side effects. One embodiment comprises a (very) low dose lithium, for example in the range of 1 microgram to 50 milligrams per liter or dose, of which research has shown to have beneficial effects on aging and health.

Here, we recognize the synergistic effect on mitigating the aging process and improving health with the following substances, comprising but not limited to, protein homeostasis improving substances (e.g. trehalose, acetyl-glucosamine and/or glucosamine), anti-amyloidogenic substances (e.g. caffeine), ginkgo biloba, glycine, Krebs cycle metabolites, or combinations thereof. For example, lithium induces clearance of proteins (autophagy) and additionally brings about epigenetic changes in the cells, while trehalose stabilizes proteins by its chaperone activity and also induces their clearance (autophagy), while caffeine inhibits aggregation of proteins by its anti-amyloidogenic activity, this all leading to improved protein homeostasis.

H) Prebiotics are substances that can induce changes in the composition or activity of microorganisms like bacteria which can contribute to the health and well-being of the host. Examples of prebiotics are fructo-oligosaccharides (FOS), galacto-oligosaccharides (GOS), xylo-oligosaccharides (XOS), larch arabinogalactin (LAG), inulines, pectin, beta-glucans, resistant starch, non-starch polysaccharides, lignin, cellulose, methylycellulose, hemicelluloses, β-glucans, mucilage, waxes, cyclodextrins, gums, chitinsarabic gum, xanthan gum, guar gum, prebiotic rich foods (e.g. chicory root, garlic, onion, oatmeal, etc.), or combinations thereof. Prebiotics can bring about beneficial changes that mitigate the aging process, for example by counteracting unfavorable aging-related changes regarding the gut bacteria composition (microbiome), stimulating the growth of beneficial bacteria like bifidobacteria or reducing aging-related whole-body inflammation (also called ‘inflammaging’). We recognize the synergistic effect on aging and health by combining prebiotics with substances like Krebs cycle metabolites (e.g. malate), lithium, anti-amyloidogenic substances (e.g. caffeine), glycine, gingko biloba and protein-homeostasis-influencing saccharide-based substances (e.g. trehalose, acetyl-glucosamine and/or glucosamine), or combinations thereof, for the reasons mentioned earlier in this document.

Compared with many ‘anti-aging’ or other health products that often contain vitamins, minerals or antioxidants, an embodiment comprising at least one protein-homeostasis-influencing saccharide-based substance (e.g. trehalose), an anti-amyloidogenic substance, a Krebs cycle metabolite (e.g. malate), glycine, gingko biloba-extract, a low dose lithium, prebiotic or a combination thereof, has a much more interesting and beneficially profound impact on the aging process and health, not only because the specific effect of each individual substance on aging-mechanisms, but even more so because their synergetic effect. We need more up-to-date and more scientifically-based methods, compositions and products to slow down and mitigate the aging process and improve health, longevity and youthfulness, especially in the light of increased awareness of the general public regarding health, aging and staying young and healthy as long as possible and in the light of the upcoming ‘silver tsunami’ constituting an exponentially increasing elderly population in many countries.

In one embodiment, at least one substance selected from the group comprising a protein-homeostasis-influencing saccharide-based substance (e.g. trehalose), an anti-amyloidogenic substance, a Krebs cycle metabolite (e.g. malate), glycine, gingko biloba, lithium, prebiotic, or a combination thereof, can be used:

a) in combination with a liquid, e.g. comprising carbonated water, flavored water, carbonated flavored water, spring water, tap water, vegetable juice, nectar juice, nectar, fruit juice, milk obtained from animals, milk product derived from soy, rice, coconut or other plant material, coffee, decaffeinated coffee, tea, tea derived from fruit products, tea derived from herb products, decaffeinated tea, wine, champagne, malt liquor, vodka, gin, rum, other hard liquors, or a combination thereof.

b) in combination with at least one potentially health-promoting substance, which can also have a senescence-retarding effect, to attain an additional synergetic effect on health, aging and metabolism, selected from the group comprising petunidin, zeaxanthin, lutein, lycopene, lutein, genistein, gossypol, crypoxanthin, reservatol, eugenol, hesperetin, ferulic acid, thymol, hydroxytyrosol, thyme, lipoic acid, glutathinone, glutamine, oxalic acid, tocopherol-derived compounds, butylated hydroxyanisole (BHA), butylated hydroxytoluene (BHT), ethylenediaminetetraacetic acid (EDTA), tert-butylhydroquinone, acetic acid, tocotrienol, tocopherol, astaxanthin, canthaxantin, saponin, rutin, limonoids, kaempfedrol, isorhamnetin, tangeritin, hesperetin, naringenin, erodictyol, flavanols, theaflavin and its gallate forms, thearubigins, malvidin, isoflavone phytoestrogens, grape seed extract, glycitein, daidzein anythocyanins, cyanidin, pomegranate, luteolin, delphinidin, pelargonidin, peonidin ellagic acid, gallic acid, cacao, cocoa, salicylic acid, cinnamic acid and its derivatives (e.g. ferulic acid), substances from spices, chlorogenic acid, chicoric acid, gallotannins, ellagitannins, anthoxanthins, betacyanins and other plant pigments, silymarin, citric acid, lignan, antinutrients, bilirubin, uric acid, N-acetylcysteine, lipoic acid, vitamin A, vitamin B, vitamin C, ubiquinone, a mineral, selenium, a carotene, an alkaloid, manganese, melatonin, emblicanin, apple extract, taurine, apple skin extract (applephenon), rooibos extract red, rooibos extract, hauthorn berry extract, red raspberry extract, green coffee antioxidant (GCA), coenzyme Q10, cocoa extract, hops extract, mangosteen extract, mangosteen hull extract, cranberry extract, aronia extract, hawthorn berry extract, pomegranate hull extract, pomegranate seed extract, pomegranate extract, cinnamon bark extract, grape skin extract, bilberry extract, pycnogenol, elderberry extract, pine bark extract, mulberry root extract, wolfberry (gogi) extract, blackberry extract, phytic acid, raspberry extract, blueberry extract, blueberry leaf extract, citrus bioflavonoids, black currant, ginger, acai powder, green coffee bean extract, green tea extract, or combinations thereof.

c) in the form of a snack.

d) in the form of a powder.

e) in the form of a skin care product.

f) in combination with at least one of the group comprising nuts, fiber, proteins, fats, carbohydrates, or a combination thereof.

g) as a food supplement.

h) added to food, beverage or other product, for example to make it more healthy.

In one embodiment, the composition comprises trehalose, caffeine and malate. In another embodiment, the composition comprises trehalose, curcumin, malate and lithium. In another embodiment, the composition comprises trehalose, caffeine, malate, lithium and oligo-fructosaccharides. In one embodiment, the composition comprises trehalose, glucosamine and caffeine. In another embodiment, the composition comprises trehalose, glucosamine and turmeric (Curcuma longa).

In one particular embodiment, lithium is present in an amount in the range of about 1 microgram to 50 milligram per liter, per dose or per drink.

In one particular embodiment, caffeine is present in an amount in the range of about 5 to 400 milligram per 250 ml.

One particular embodiment describes a powder or a beverage that comprises trehalose, caffeine, malate, glycine and fructo-oligosaccharides. In a more specific embodiment, a beverage comprises trehalose in an amount in the range of 0.1 to 100 gram per 250 ml, caffeine in an amount in the range of 1 mg to 400 mg per 250 ml, malate in an amount in the range of 1 mg to 30 gram per 250 ml, lithium in an amount in the range of 1 microgram to 50 milligram per 250 ml and fructo-oligosaccharides in an amount in the range of 1 milligram to 20 gram per 250 ml.

One particular embodiment describes a meal replacement, healthy meal or meal alternative, comprising a carbohydrate source (or carbohydrates), a fat source (or fats) and an amino acid source (or amino acids or proteins), further comprising at least one of:
at least one protein-homeostasis-influencing saccharide-based substance comprising trehalose, mannitol, glucosamine, acetyl-glucosamine, galactosamine, mannosamine or combinations thereof
a Krebs-cycle metabolite selected from the group comprising malate, fumarate, pyruvate or combinations thereof
an anti-amyloidogenic substance, selected from the group comprising caffeine, curcuminoids, polyphenols or combinations thereof
at least one selected from the group comprising glycine, ginkgo biloba, lithium, a prebiotic or combinations thereof
a sugar alcohol selected from the group comprising erythritol, maltitol, xylitol, sorbitol, mannitol, arabitol, or combinations thereof.

This healthy meal or meal replacement can be complimented with specific vitamins, minerals and health promoting compounds, giving the consumer of such a meal various benefits, like:

1) A fast and easily prepared meal that delivers macronutrients (carbohydrates, fats and amino acids) and micronutrients (e.g. vitamins, minerals, phytochemicals, . . . ).

2) A healthy meal that can slow down aging, promote healthy living and healthy aging.

In one specific embodiment, this healthy meal replacement comprises approximately one third of the average required daily calories of a human adult, approximately one third of the average required daily dose of vitamins and minerals and physiologically active amounts of protein-homeostasis-influencing saccharide-based substances and senescence-retarding substances described in this patent application, e.g. trehalose, mannitol, glucosamine, acetyl-glucosamine, malate, fumarate, pyruvate, glycine, ginkgo biloba, lithium, a prebiotic or combinations thereof.

The composition may be administered or co-administered by a wide variety of routes, preferentially orally, but further also including but not limited to sublingually, parenterally, intraperitoneally, intravenously, intra-arterial, transdermally, intramuscularly, rectally, transbuccally, intranasally, liposomally, via inhalation, vaginally, intraocularly, via local delivery (for example by catheter or stent), subcutaneously, intrathecally or intraadiposally. The composition may also be administered or co-administered in slow release dosage forms.

It is emphasized that the effects on aging and health (like improving protein homeostasis or mitochondrial function) described in this patent application may not be the only mechanisms by which the substances mentioned in this application (e.g. trehalose, glucosamine, acetyl-glucosamine, anti-amyloidogenic substances (e.g. caffeine, curcuminoids), lithium, glycine, ginkgo biloba, prebiotics, etc) can exert their beneficial effect on the aging process and health. They can also mitigate aging and improve or maintain health via various other mechanisms, for example by influencing the function of specific proteins, interfering with specific cellular pathways, etc.

It is also emphasized that acetyl-glucosamine or glucosamine can be replaced with other saccharide-based molecules, like galactosamine and mannosamine, since for example galactosamine and mannosamine can also induce autophagy and also can have a synergistic effect together with substances like trehalose, glucosamine and acetyl-glucosamine.

It is recognized that the synergistic and enhancing effect of saccharide-based molecules that have a chaperone activity (e.g. trehalose, mannitol, . . . ) on other protein-homeostasis-influencing molecules like glucosamine, acetylglucosamine, anti-amyloidogenic molecules, Krebs cycle molecules, lithium, gingko biloba, prebiotics is not limited to only the molecules described in this patent application (e.g. trehalose, mannitol) but can also work for other saccharide-based molecules with chaperone activity, which are often, but do not need to be, molecules that are used as sweeteners.

It is also emphasized that the possible kinds of sugar alcohols that can be incorporated in an embodiment are not limited to the sugar alcohols mentioned in this patent application (e.g. erythritol, maltitol, xylitol, sorbitol, arabitol), which are only listed as examples, but include all sugar alcohols available in nature or that can be synthesized.

Krebs cycle metablites and their ionized and non-ionized forms, like malate and malic acid, fumarate and fumaric acid, can be used interchangeably.

Some embodiments can theoretically also be of use in reducing the risk, prevention, the retardation or treatment of various diseases, especially aging-related diseases, like cardiovascular disease (e.g. atherosclerosis, high blood pressure, heart failure, heart valve dysfunction, calcification of arteries and valves, etc), neurodegenerative disease (e.g. Alzheimer's disease, vascular dementia, Lewy-body disease, frontotemporal dementia, Parkinson disease, mild cognitive impairment, amyotrophic lateral sclerosis, etc), musculoskeletal diseases (e.g. rheumatoid arthritis, osteoarthritis, osteoporosis, etc), metabolic disorders and diseases (e.g. diabetes, obesity, cancer, thyroid disorders, metabolic syndrome, fatty liver, steatohepatitis, etc), lung diseases (e.g. lung fibrosis, etc), aging-related gastro-intestinal diseases (constipation, decreased stomach and gut motility, gastroparesis, polyps, gut dysbiosis, etc), blood diseases (leukemia, lymphoma, anemia, platelet disorders, coagulation disorders, multiple myeloma, myelodysplastic syndromes, myeoloproliferative disorders, etc), aging-related skin diseases, aging-related kidney diseases, and other aging-related diseases since aging is an important risk factor in such diseases.

Since some embodiments want to slow down the aging process and increase life span and health, they also can theoretically slow down the origin and progression of aging-related symptoms, like the formation of wrinkles, sagging skin, aged skin, reduced stamina, reduced eye sight, reduced hearing, sarcopenia (decrease in muscle mass), insulin resistance, fat deposition (e.g. abdominal fat), hair graying, hair loss, baldness, loss of libido, erectile dysfunction, memory problems, reduced cognition, concentration problems, memory problems, sleep disorders, mood disorders, and other aging-related symptoms.

Recognized is that aging substantially affects metabolism in a negative way, so some embodiments will also have a positive impact on metabolism, since they synergistically act on protein metabolism, mitochondrial metabolism, epigenetic regulation of metabolism, etc.

Additionally, some embodiments have the potential to reduce body weight since they can improve for example autophagy (including lipophagy—the digestion of lipids) and improve metabolism (e.g. mitochondrial functioning) which can lead to weight loss or reduced weight gain.

All the described substances in this patent can be used alone or in a combination.

All values described throughout this application, including the claims are deemed to be approximate, whether or not the term ‘about’ or ‘approximately’ is used, unless specifically stated as exact.

### REFERENCES

(1) Bjelakovic, G., Nikolova, D., Gluud, L. L., Simonetti, R. G. & Gluud, C. Mortality in randomized trials of antioxidant supplements for primary and secondary prevention: systematic review and meta-analysis. JAMA 297, 842-57 (2007).
(2) Macpherson, H., Pipingas, A. & Pase, M. P. Multivitamin-multimineral supplementation and mortality: a meta-analysis of randomized controlled trials. Am. J. Clin. Nutr. 97, 437-44 (2013).
(3) Sesso, H. D. et al. Multivitamins in the prevention of cardiovascular disease in men: the Physicians' Health Study II randomized controlled trial. JAMA 308, 1751-60 (2012).
(4) Sayin, V. I. et al. Antioxidants accelerate lung cancer progression in mice. Sci. Transl. Med.6 (2014).
(5) Ristow, M. et al. Antioxidants prevent health-promoting effects of physical exercise in humans. Proc. Natl. Acad. Sci. U.S.A 106, 8665-70 (2009).
(6) Yang, W. & Hekimi, S. A mitochondrial superoxide signal triggers increased longevity in Caenorhabditis elegans. PLoS Biol. 8 (2010).

### ADDITIONAL REMARKS

Inventor: Kris Verburgh, Hauchecornestraat 33, 2870 Puurs, Belgium

Priority: I hereby claim priority benefits in this PCT patent application, which claims priority of provisional patent application Ser. No. 62/266,632, filed on 13 Dec. 2015 at the United States Patent and Trademark Office (USPTO).

1. A method to slow down and mitigate the aging process and to maintain health comprising administering a composition to an organism, in which the composition comprises: a) at least one protein-homeostasis-influencing saccharide-based substance;
b) at least one senescence-retarding substance.

2. The composition of claim 1, wherein the protein-homeostasis-influencing saccharide-based substance is selected from the group consisting of trehalose, mannitol, glucosamine, acetyl-glucosamine, galactosamine, mannosamine or combinations thereof, whereby their synergistic effect on the aging process is recognized.

3. The composition of claim 1, wherein the senescence-retarding substance is selected from the group consisting of an anti-amyloidogenic substance, Krebs cycle metabolite, glycine, ginkgo biloba, lithium, a prebiotic or combinations thereof, whereby their synergistic effect on the aging process is recognized.

4. The composition of claim 3, wherein the anti-amyloidogenic substance is selected from the group consisting of caffeine, a curcuminoid, a polyphenol or combinations thereof.

5. The composition of claim 3, wherein the Krebs cycle metabolite is selected from the group consisting of malate, fumarate, pyruvate or combinations thereof.

6. The composition of claim 2, further including an anti-amyloidogenic substance, whereby their synergistic effect on aging is recognized.

7. The composition of claim 1, further including at least one sugar alcohol selected from the group consisting of erythritol, maltitol, xylitol, sorbitol, arabitol or combinations thereof.

8. The composition of claim 1, further including a carbohydrate source, a fat source and an amino acid source.

9. The composition of claim 7, further including a carbohydrate source, a fat source and an amino acid source.

10. A method to slow down and mitigate the aging process and to maintain health comprising administering a composition to an organism, in which the composition comprises: two or more protein-homeostasis-influencing saccharide-based substances selected from the group consisting of trehalose, mannitol, glucosamine, acetyl-glucosamine, galactosamine, mannosamine or combinations thereof, whereby their synergistic effect on the aging process is recognized.

11. The composition of claim 10, further including a senescence-retarding substance.

12. The composition of claim 11, wherein at least one senescence-retarding substance is selected from the group consisting of an anti-amyloidogenic substance, Krebs cycle metabolite, glycine, ginkgo biloba, lithium, a prebiotic or combinations thereof, whereby their synergistic effect on the aging process and metabolism is recognized.

13. The composition of claim 10, further including at least one sugar alcohol selected from the group consisting of erythritol, maltitol, xylitol, sorbitol, arabitol or combinations thereof.

14. The composition of claim 10, further including a carbohydrate source, a fat source and an amino acid source.

15. The composition of claim 13, further including a carbohydrate source, a fat source and an amino acid source.
